(19) United States
(12) Patent Application Publication
(10) Pub. No.: US 2007/0015547 A1
(43) Pub. Date: Jan. 18, 2007

(54) Wall mounted cellphone holder

(76) Inventor: Kara Jo Grier, San Diego, CA (US)

Correspondence Address: Kara J. Grier, 6105 DOROTHY DR, San Diego, CA, 92115, US

(21) Appl. No.: 11/200,716

(22) Filed: Aug. 11, 2005

Related U.S. Application Data
(60) Provisional application No. 60/698,901, filed on Jul. 14, 2005.

(51) Int. Cl. H04Q 7/32

(52) U.S. Cl. 455/569.1; 455/550.1

(57) ABSTRACT

A universal cellphone holder that mounts to a vertical surface that accommodates various cellphone types when the cellphone is not in use or during the cellphone battery recharging phase.

### CROSS-REFERENCE TO RELATED APPLICATIONS

This application claims priority to provisional application 60/689,901 filed on Jul. 14, 2005.

This application is derived from provisional patent application 60/689,901 filed on Jul. 14, 2005 for invention titled “Wall Mounted Cellphone Holder” by Kara Jo Grier.

### FEDERALLY SPONSORED RESEARCH

Not Applicable

### SEQUENCE LISTING OR PROGRAM

Not Applicable

### BACKGROUND OF THE INVENTION

### Field of Invention

This invention relates to manufactured items whose specific function is to hold a cellphone when the device is not in use or during the recharging phase of the cellphone battery. These devices do not supply a charge to the phone. They are for decorative and functional purposes only.

### SUMMARY OF THE INVENTION

Current decorative and functional cellphone holders rest on a horizontal surface such as a counter top, table or desk and hold the cell phone when not in use or during the recharging phase of the cellphone battery. This invention will allow for the cellphone to be stored in a vertical holder that is attached to a vertical surface when not in use or during the recharging phase.

### BRIEF DESCRIPTION OF DRAWINGS

FIG. 1 is of the front view of the wall mounted cellphone holder.

FIG. 2 is of the front view of the wall mounted cellphone holder.

FIG. 3. is a side view of the wall mounted cellphone holder.

FIG. 4 is a back view of the wall mounted cellphone holder.

FIG. 5 is a three-quarter view of the wall mounted cellphone holder.

FIG. 6 is a top view of the wall mounted cellphone holder.

FIG. 7 is a front view of the wall mounted cellphone holder.

FIG. 8 and FIG. 9 are views depicting the rubber gasket of the wall mounted cellphone holder.

FIG. 10 is a bottom view of the wall mounted cellphone holder.

### DETAILED DESCRIPTION OF DRAWINGS

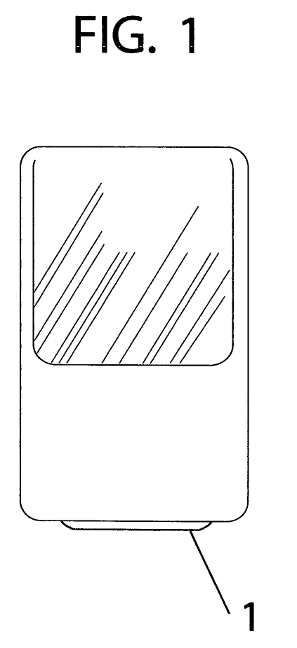

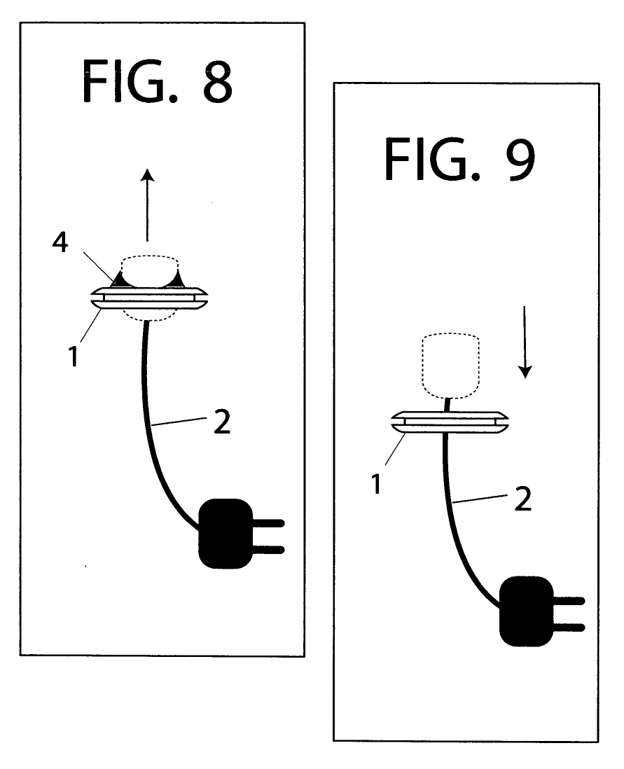

FIG. 1 shows a front view of the cellphone holder of the present invention. The numeral “1” depicts a semi-flexible rubber gasket inserted into an opening in the base of the holder through which the charging unit can be attached to the cell phone for charging. This gasket has a recessed groove that will accommodate the thickness of the material used to construct the holder and an upper and lower lip to secure the gasket once in place. Please see additional description for numeral “1” as noted in description for FIG. 8 and FIG. 9.

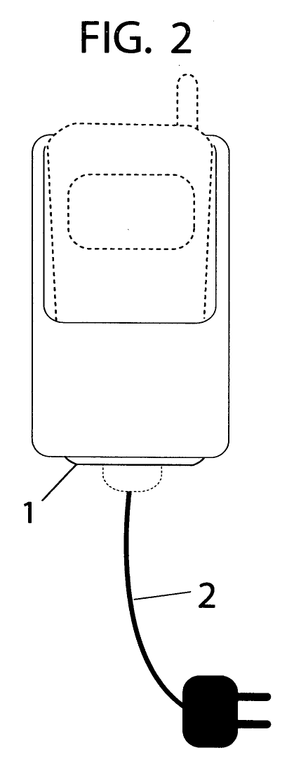

FIG. 2. shows a front view of the cellphone holder with a representative drawing of a cell phone indicated by the dotted line. The numeral “1” is described in FIG. 1. The numeral “2” depicts a representational drawing of a cell phone charging device.

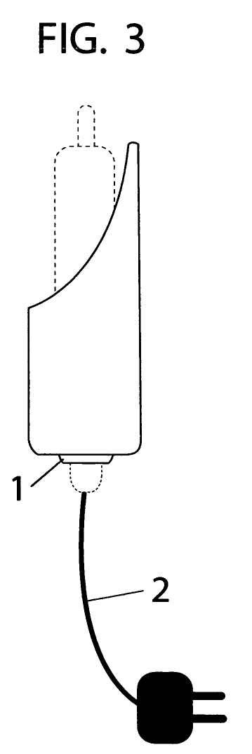

FIG. 3. shows a side view. Both sides are to be constructed in the same manner therefore this view is representative of both the right and the left side views. The numeral “1” is described in FIG. 1. The numeral “2” is described in FIG. 2.

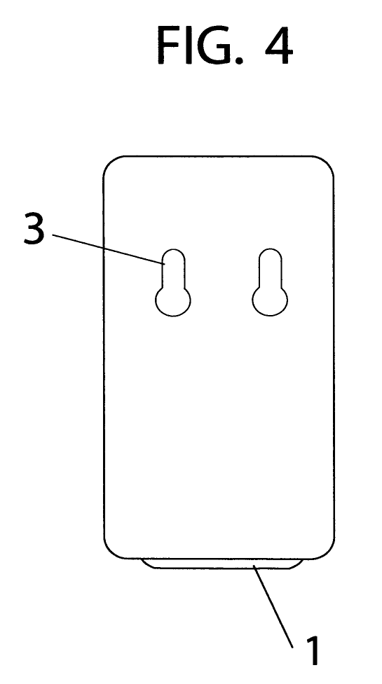

FIG. 4. shows the back view of the cellphone holder. This side mounts to wall by two recessed keyhole slots. The numeral “3” depicts keyhole slots. Numeral “1” is described in FIG. 1.

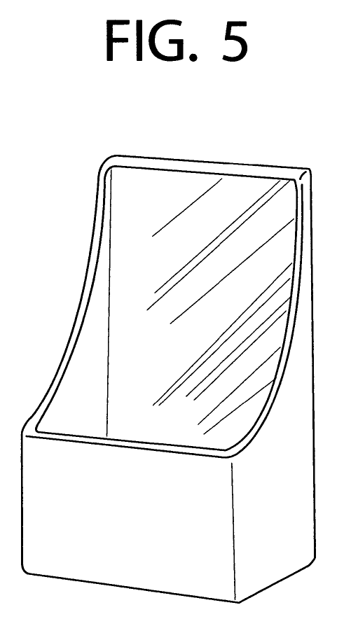

FIG. 5. shows a three-quarter perspective of the cellphone holder.

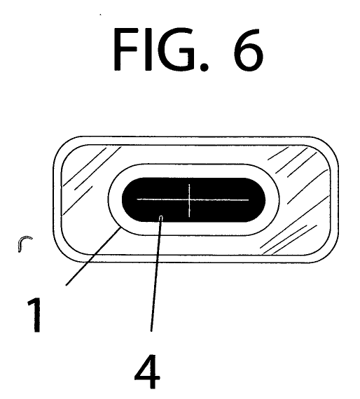

FIG. 6. shows the top view of the cell phone holder looking into the open area which will house the cellphone when not in use. The numeral “1” is as described. FIG. 1. The shaded area marked with the numeral “4” represents a thin flexible skin of rubber with two cuts, one made vertically and one made horizontally, that allow for the charging device to be inserted through the base of the holder and into the base of the cellphone. The shaded area depicts the opening through which a charging device will plug into the base of a cellphone.

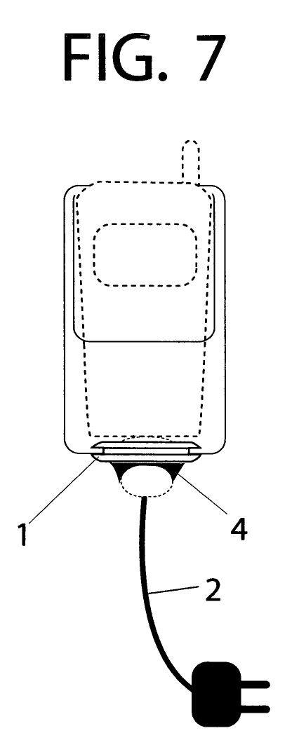

FIG. 7. shows the front view of the cellphone holder. The numerals “1”, “2” and “4” are as described above.

FIG. 8 and FIG. 9 These views are illustrative of the manner in which the charging device should be inserted into the rubber gasket at the bottom of the cellphone holder.

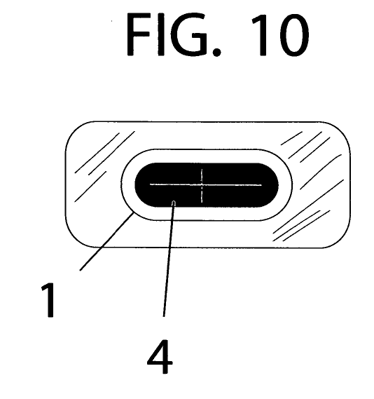

FIG. 10 shows a bottom view of the holder. Numerals “1” and “4” are as described above.

The broken lines depicting the cellphone, the broken lines at the base of cellphone, and the solid black illustration of charging cord are for illustrative purposes only and form no part of the claimed invention.

### SUMMARY OF DISCLOSURE

This invention provides a decorative and functional holder that mounts to a vertical surface which enables a cellphone to be stored when not in use or during the recharging phase.

### DESCRIPTION OF PREFERRED EMBODIMENT

The invention depicted in this patent application can be manufactured from one or all or any combination of the following materials: plastics, vinyl, ceramic, wood, metal, paper, resin, glass, or rubber. The invention depicted in this application also serves as a base form whose surfaces can be enhanced by decoration as outlined, in general, below:

1) interior and exterior surfaces receive a color treatment such as hand painting or color impregnated in base material. It may have text or graphic embellishment, lenticular graphics or licensed imagery.

2) a base form whose interior and primary function remains unaltered and on whose exterior surface three dimensional sculptural embellishments can be applied. These elements would either be attached to the existing surface or be produced in the base mold.

3) a base form whose interior and primary function remains unaltered and whose exterior surface is fully three dimensionally sculpted.

While the invention has been illustrated and described as embodied in a wall mounted cellphone holder, it is not intended to be limited to the details shown in this patent application as it will be understood that various omissions, modifications, substitutions and changes with regard to forms, materials and other details of the device illustrated and in its operation can be made by those skilled in the art without departing from the spirit of the present invention in any way.

Without further analysis, the information outlined in the foregoing patent application reveals the full gist of the present invention that others can when applying current knowledge readily adapt it for various applications without omitting features or details that from the standpoint of prior art, fairly constitute the essential characteristics of the generic or specific aspects of this invention.

I claim:

1) A cellphone holder that can be fixed or attached to a vertical surface with screws or other such hanging device.

2) A cellphone holder that can accommodate cellphones of various types that can be placed in the interior of the cellphone holder.

3) The cellphone holder provides an area for the insertion of a cellphone charging devise

4) The cellphone holder can be made of a variety of materials.

5) The cellphone holder can be constructed in various sizes.
